(19) United States
(12) Patent Application Publication
(10) Pub. No.: US 2014/0313469 A1
(43) Pub. Date: Oct. 23, 2014

(54) RECONFIGURABLE 1xN FEW-MODE FIBER OPTICAL SWITCH BASED ON A SPATIAL LIGHT MODULATOR

(71) Applicant: NEC Laboratories America, Inc., Princeton, NJ (US)

(72) Inventor: Ezra Ip, Plainsboro, NJ (US)

(73) Assignee: NEC Laboratories America, Inc., Princeton, NJ (US)

(21) Appl. No.: 14/243,218

(22) Filed: Apr. 2, 2014

Related U.S. Application Data
(60) Provisional application No. 61/814,557, filed on Apr. 22, 2013.

(51) Int. Cl. G02F 1/313

(52) U.S. Cl. CPC G02F 1/3132; G02F 2001/3135
USPC 349/196; 359/238

(57) ABSTRACT

An optical switch includes an array of parallel few-mode fibers stacked vertically; beam stretchers that modifies an aspect ratio between a height and a width of beams associated with each few-mode fiber; a spatial light modulator with a 2D array of independently programmed tunable pixels, wherein the spatial light modulator manipulates phase and/or amplitude at each position of an incident optical beam; a wavelength demultiplexer which can separate the spectral components of an incident beam in angle; and lenses for imaging the modes of the input array of fiber to the spatial light modulator.

This application claims priority to Provisional Application Ser. No. 61/814,557 filed Apr. 22, 2013, the content of which is incorporated by reference.

### BACKGROUND

The present invention relates to an optical switch.

As the capacity of single-mode fiber is exhausted, space-division multiplexing (SDM) has emerged as an active research topic to allow continued growth in capacity per fiber. The goal of SDM is cost reduction. This requires device integration, and calls for new amplifiers, switches, filters, and other components that can process parallel optical channels in a single device.

Mode-division multiplexing (MDM) using few-mode fiber (FMF) has emerged as a promising SDM solution. Recently, wavelength-division multiplexed and mode-division multiplexed (WDM-MDM) transmission has been demonstrated in a few-mode fiber re-circulating loop that uses a few-mode erbium-doped fiber amplifier (FM-EDFA) to simultaneously amplify all of the propagating signal modes. In one experiment, the achieved transmission distance was limited by wavelength-dependent gain of the FM-EDFA. Even in single-mode fiber (SMF) transmission over long-haul distances, gain flattening filters (GFF) need to be inserted periodically to ensure flatness of the transmitted signal spectrum. While GFFs employing a variety of technologies is commercially available for SMF, no GFF based on FMF has been demonstrated to date. Thus, in the WDM-MDM experiment, wavelengths near the peak of the FM-EDFA gain spectrum have net gain per loop, while other wavelengths have net loss per loop. As signal quality is degraded by both amplifier noise and Kerr nonlinearity, there exists an optimum launch power per mode per WDM channel. Wavelength-dependent gain (WDG) is a significant impact on system performance. For example, WDG of only 1 dB will result become 10 dB after only 10 spans, so the launch powers of the WDM channels will be far from optimal after only a few spans.

To increase system reach, WDG needs to be compensated. It may be possible to fabricate fixed GFFs in FMF that inverts the WDG of the FM-EDFA. However, WDG is a function of pump power and input signal power, which will vary with the link. For transmission over many fiber spans, tunable GFFs are required even in SMF systems to compensate residual WDG ripples. Thus, there is a need to develop tunable GFFs for FMF. One method of accomplishing the GFF function, as well as to enable compensation of mode-dependent gain (MDG), is by “parallel processing,” where a mode demultiplexer (M-DEMUX) is used to recover the optical field of each mode. A bank of parallel single-mode amplifiers and GFFs are then used to compensate WDG and MDG, while a mode multiplexer (M-MUX) reconstitutes the MDM signal. The disadvantage is that the number of amplifiers and GFFs must equal the number of propagating modes. Not only is there no reduction in component count, the system is made more complex by the M-MUX/DEMUXes. Just as it is desirable to have FM-EDFAs that can simultaneously amplify all of the signal modes in a single device, it is desirable to have a few-mode gain flattening filter (FM-GFF) that can compensate WDG (and perhaps MDG) in all the modes in a single device.

In SMF, gain flattening filters (GFF) have been fabricated using long-period fiber gratings. Once the grating has been written, the filtering function is fixed, subject to only minor fluctuations with temperature changes. To enable a widely tunable filter shape, more advanced technology is required.

Spatial light modulators (SLM) based on liquid crystal on Silicon (LCoS) have emerged as a popular platform for realizing tunable gain-flattening filters in single-mode fiber, which are also known as “wave shapers.” A multi-pixilated LCoS SLM enables precise control of the phase and/or amplitude of the incident light at each point of its wave front. In a GFF, there is one input fiber and one output fiber; the SLM reflects the incident light from the input fiber to the output fiber while inducing an arbitrary loss profile across wavelength. Adding more output fibers to the architecture enables the GFF to be converted into an optical switch.

While it appears that swapping the SMFs in current optical switches with FMFs will allow the same functions to be realized in FMF, in practice, the optical beams needs to be more carefully managed in the case of FMF. For example, beam misalignment in SMF will result in higher insertion loss, which is exploited by a single-mode GFF to program an arbitrary loss profile across wavelength. In FMF, beam misalignment will result in mode coupling. Since the coupling matrix is typically non-unitary, the concatenation of multiple devices with misaligned beams will cause the channel matrix to have large spread in singular values, leading to mode-dependent loss (MDL), which will cause system outage. Hence, the manner in which the optical beams are managed inside the switch, and the manner in which insertion loss is induced by the SLM needs to be different in an FMF-based GFF (or switch) than in a SMF-based GFF (or switch).

Apart from enabling networking functions to be performed for FMF, the GFF function itself is crucial for long-haul transmission in FMF, where wavelength-dependent gain (WDG) of few-mode erbium-doped fiber amplifiers (FM-EDFA) will limit transmission distance. While the GFF function and switching can be implemented naïvely by demultiplexing the modal components, followed by single-mode devices for amplification, filtering and switching, this straightforward scheme require as many components as the number of propagating modes, resulting in no savings comparing with running M single-mode systems in parallel. To date, tunable SLM-based gain-flattening filters and switches have only been realized in SMF. On the other hand, FMF-based switches either enables no wavelength-switching, or the wavelength plan is not tunable, or the architecture needs as many components as running M parallel SMF systems, thus offering no cost advantage.

### SUMMARY

In one aspect, an optical switch includes an array of parallel few-mode fibers stacked vertically; beam stretchers that modifies an aspect ratio between a height and a width of beams associated with each few-mode fiber; a spatial light modulator with a 2D array of independently programmed tunable pixels, wherein the spatial light modulator manipulates phase and/or amplitude at each position of an incident optical beam; a wavelength demultiplexer which can separate the spectral components of an incident beam in angle; and lenses for imaging the modes of the input array of fiber to the spatial light modulator.

Advantages of the preferred embodiment may include one or more of the following. The system realizes tunable GFF and switching functions for FMF in a single device. The system reduces cost with a single device that can perform gain-flattening and switching for all modes simultaneously. The spatial light modulator, whose individual pixels represents degrees of freedom by which to manipulate the spectral and modal content of the incident beam, is exploited for the reduction of component count, allowing gain-flattening and switching for FMF in a single device.

### BRIEF DESCRIPTION OF THE DRAWINGS

FIG. 1 shows an exemplary top view and front view of an exemplary optical switch.

FIG. 2 shows an exemplary beam stretcher based on two pairs of cylindrical lenses.

FIG. 3 shows an exemplary Spatial Light Modulator (SLM) with pixels relative to the spectrally separated beams.

### DESCRIPTION

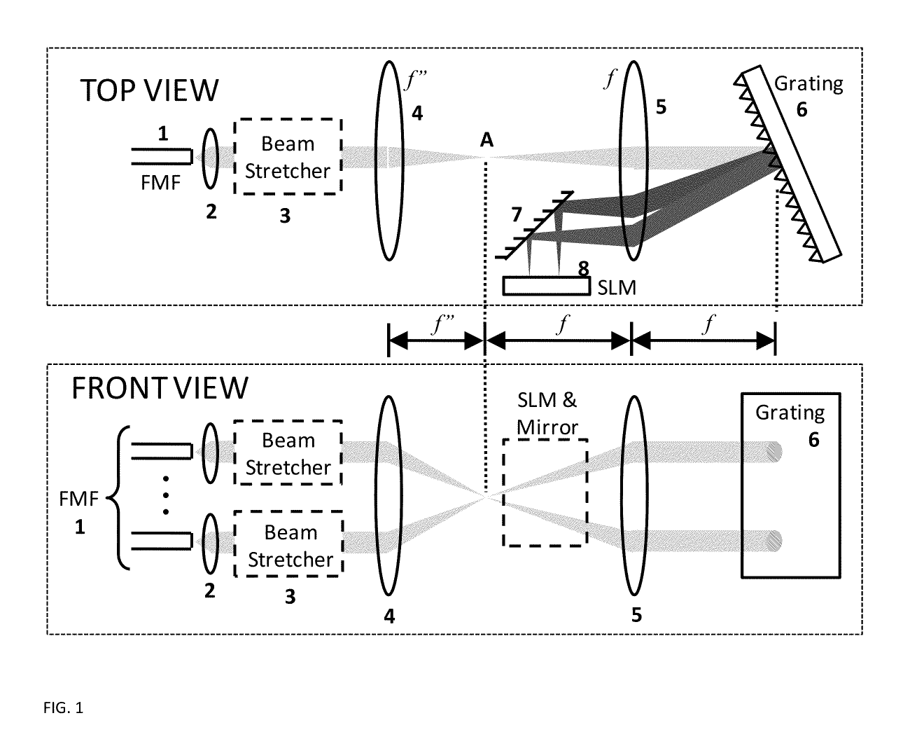

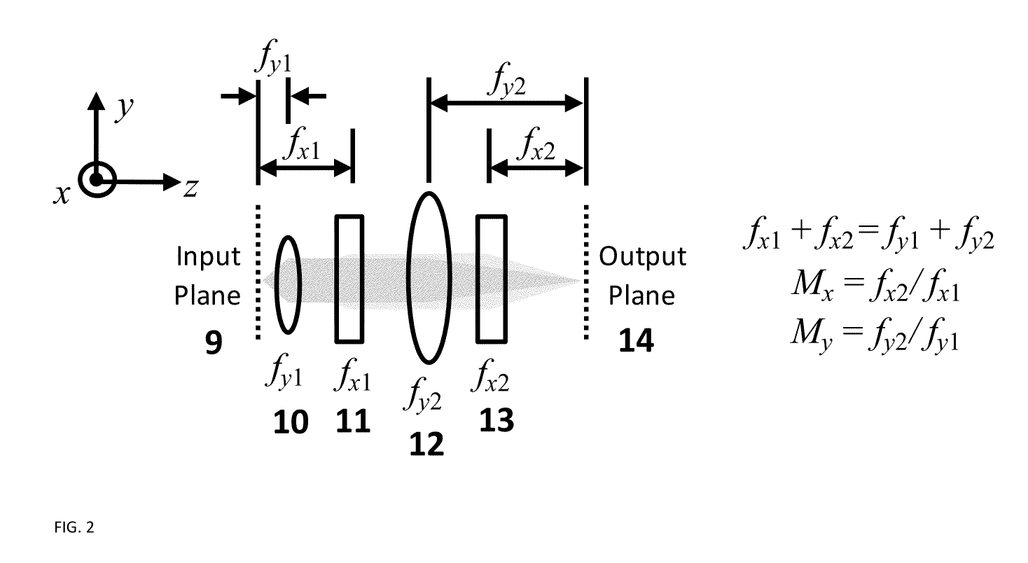

FIG. 1 shows an exemplary top view and front view of an exemplary optical switch. The input comes from an array of parallel few-mode fibers (FMFs) stacked on top of each other in one direction such as a vertical direction (1). One of these FMF is designated as the “input fiber,” while the other N fibers are designated as “output fibers.” Each of the N+1 fiber is terminated by a collimator (2). The beams pass through optional “beam stretchers” (3) which changes the aspect ratio between the height and width of the beams emanating from each fiber (FIG. 2). A large aperture lens (4), referred to as Lens 1 having focal length f′ focuses the beams to a common point A, converting the spatially separated beams into converging beams separated in angle in the vertical plane. At a distance f from point A, a second lens (5), referred to as Lens 2 having focal length f parallelize the beams again; where at a distance f from Lens 2, a dispersive diffraction grating (6) demultiplexes the spectral components of the incident beams in angle in the horizontal plane (red and blue beams in Top View). The diffracted beams pass through Lens 2 (5) again. Since on this pass, the spectral components arrive at Lens 2 at different angles in the horizontal plane, Lens 2 convert the spectral components into parallel beams in the horizontal plane. A mirror (7) behind Lens 2 reflects the spectrally separated light to the spatial light modulator (8). The optical distance between the SLM and Lens 2 is f. This ensures that in the vertical plane, the beams corresponding to each FMF impinge on the SLM at different angles. Thus for a given spectral component, programming a vertical slice of the SLM with a linear phase mask in the vertical direction causes it to act like a mirror, and that spectral component can be switched from the input FMF to any of the N output FMFs.

The reflected light from the SLM first traverses through Lent, where the dispersive grating multiplexes the spectral components back into a single beam per FMF in the vertical plane. After passing through Len 2, Lens 1 and the beam stretcher, the output light is coupled into the array of FMFs.

In the architecture of FIG. 1, the lenses (including those inside the beam stretcher described below) are arranged such fashion that either an image of the modes of the FMFs, or their 2D spatial Fourier transforms are to be found at their foci. In particular, the portion of the device from point A to the SLM forms a 4f imaging system with unity magnification factor. We assume the SLM is polarization-insensitive and has a 2D array of pixels which can be independently programmed.

The sharpness of the filtering function realizable by the device is inversely proportional to the horizontal beam width at the SLM. This is because wavelength (frequency) is mapped to the horizontal axis at the SLM. If a vertical edge is programmed on the SLM pixels, the wider the incident beam of each spectral component, the more spectral components will have a beam that overlap the vertical edge, resulting in a filtering function with shallower roll-off in wavelength (frequency). It can also be shown that mode coupling will occur in the roll-off region. Thus, reducing the beam width in the horizontal axis enables sharper roll-off and better performance.

By contrast, it is desirable to have a wider beam in the vertical axis as this is the plane in which switching occurs. In the extreme scenario where the beam is only a single pixel high in the vertical direction, it is impossible for the SLM to reflect it at a different angle. Since the SLM pixels have finite width, having a wider beam relative to the pixel size enables the SLM to induce a smoother linear phase in the vertical direction, reducing insertion loss and undesired mode coupling.

Gain-flattening and switching has only been demonstrated in single-mode fiber. To enable the same functionality for few-mode fiber, firstly, the bank of input and output fibers need to be changed to FMF. However, FMF suffers from mode coupling. In addition, the mode sizes in FMF are larger. Since wavelength is dispersed to the horizontal axis of the SLM, larger beam sizes result in poor frequency characteristics.

To overcome poor frequency characteristic, we use “beam stretchers” to change the aspect ratio of the FMF modes. The “beam stretcher” squeezes the beam in the horizontal direction to allow a sharper filtering function, while expanding the beam in the vertical direction to enable lower mode coupling and better switching capabilities.

To overcome mode coupling, a new method of inducing insertion loss is required. Rather than misaligning the beam with respect to the output fiber, we program a phase dither to the SLM pixels to scatter a portion of light away from the output fibers. Since this scattering is in all directions and uniform for all modes, arbitrary insertion loss can be induced with low crosstalk and low mode coupling.

FIG. 2 shows an exemplary beam stretcher based on two pairs of cylindrical lenses. To satisfy both the requirements of the beam being narrow horizontally and wide vertically, we use “beam stretchers” to change the aspect ratio of the FMF modes. One configuration is shown in FIG. 2, and comprises of two pairs of cylindrical lenses. The pair of horizontal cylindrical lenses (11 and 13) have focal lengths of fₓ₁ and fₓ₂; while the pair of vertical cylindrical lenses (10 and 12) have focal lengths of f_{y1} and f_{y2}. Provided that the focal lengths satisfy fₓ₁+fₓ₂=f_{y1}+f_{y2}, it is possible to place the lenses at exactly their focal length from the input (9) and output (14) planes. Thus, the image formed at the output plane will be magnified by Mₓ=fₓ₂/fₓ₁ horizontally and M_{y}=f_{y2}/f_{y1} vertically relative to the image at the input plane. Mₓ and M_{y} can be chosen independently.

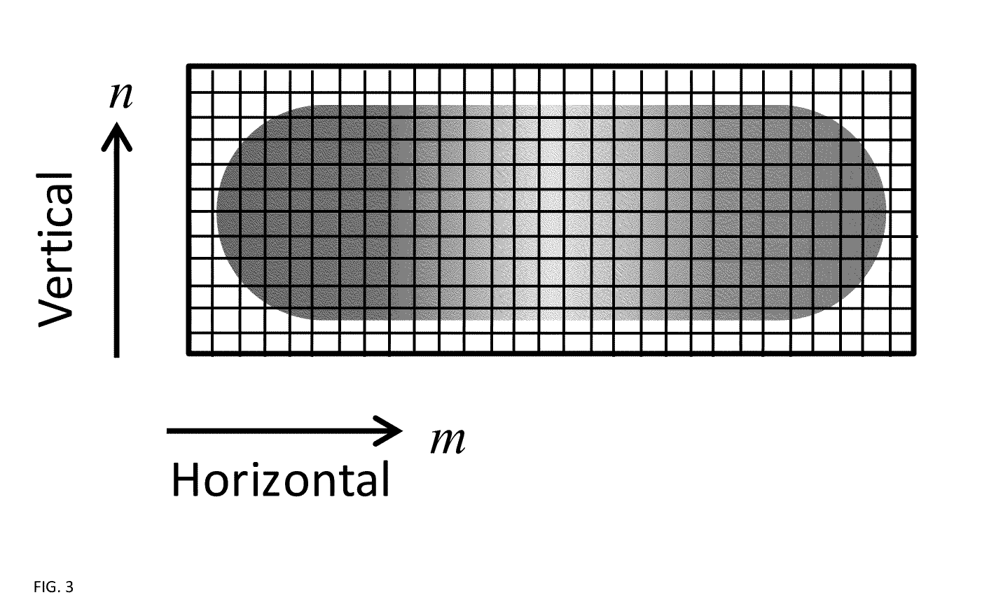

FIG. 3 shows an exemplary Spatial Light Modulator (SLM) with pixels relative to the spectrally separated beams. The spatial light modulator can be used for constructing a few-mode fiber optical switch, and mode coupling can occur at the passband edges. To minimize guard band requirements, the horizontal beam waist at the face of the SLM is minimized. SLM phase dithering was shown to be an effective technique for inducing uniform insertion loss across all the modes with low mode coupling.

In the architecture, switching and filtering are accomplished by programming the pixels of the SLM. Since the beams from the FMFs impinge on the SLM at different angles, programming vertical slices of the SLM as “mirrors” will cause that spectral component to be switched from the designated input FMF to any of the N output FMFs. Let (m,n) denote the pixel at the intersection of the m-th column and n-th row on the SLM. For a spectral component impinging on the SLM at column l, it is possible to program the phases of a vertical strip of pixels to:

$$φ ( m , n ) = \frac{2 πΛ}{λ} n sin θ + ψ ( m , n ) , \\ for l - Δ \leq m \leq l + Δ ,$$

where Λ is the height of the SLM pixels, and λ is the wavelength of the incident light. If ψ(m,n)=0, a vertical strip of the SLM 2Δ+1 pixels wide acts as a mirror reflecting the incident beam by vertical angle θ. To induce an insertion loss on the reflected beam, it is possible to set ψ(m,n) as a random phase dither. This phase dither will scatter a portion of the incident light away from the destination FMF. The amount of insertion loss induced can be controlled by changing the variance of the phase dither σ_{ψ}²=E[|ψ(m,n)|²].

The device allows switching and filtering functions be performed in a single device that process all the modes of the FMF simultaneously. The cost of the system is expected to be similar as that of a SMF-based device, enabling cost reduction per bit by the number of modes supported by the FMF. In contrast, conventional GFF and switches have architecture that either does not allow tunable switching, or requires spatial demultiplexing/multiplexing of the mode-multiplexed signal to allow switching and filtering functionality be performed using existing SMF-based devices. In the latter case, the component count is the same as running SMF links in parallel, thus offering no cost reduction.

In the instant system, “beam stretchers” are used to manipulate the modes of the FMF array in such fashion so that the SLM can do switching and gain flattening optimally. Secondly, the system adds phase dithering to the SLM pixels to induce insertion loss enable gain flattening with low crosstalk and low mode coupling.

The techniques described herein may be implemented in hardware, software, firmware, or any combination thereof. Various features described as modules, units or components may be implemented together in an integrated logic device or separately as discrete but interoperable logic devices or other hardware devices, including optical hardware components. In some cases, various features of electronic circuitry may be implemented as one or more integrated circuit devices, such as an integrated circuit chip or chipset.

If implemented in hardware, this disclosure may be directed to an apparatus such a processor or an integrated circuit device, such as an integrated circuit chip or chipset. Alternatively or additionally, if implemented in software, the techniques may be realized at least in part by a computer-readable medium comprising instructions that, when executed, cause a processor to perform one or more of the methods described above. For example, the computer-readable medium may store such instructions.

A computer-readable medium may form part of a computer program product, which may include packaging materials. A computer-readable medium may comprise a computer data storage medium such as random access memory (RAM), synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code or instructions may be executed by one or more processors, such as one or more DSPs, general purpose microprocessors, ASICs, field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software modules or hardware modules.

The embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled. Various aspects have been described in this disclosure. These and other aspects are within the scope of the following claims.

What is claimed is:

1. An optical switch, comprising:
an array of parallel few-mode fibers stacked vertically;
beam stretchers that modifies an aspect ratio between a height and a width of beams associated with each few-mode fiber;
a spatial light modulator with a 2D array of independently programmed tunable pixels, wherein the spatial light modulator manipulates phase and/or amplitude at each position of an incident optical beam;
a wavelength demultiplexer to separate the spectral components of an incident beam in angle; and
lenses for imaging the modes of the input array of fiber to the spatial light modulator.

2. The switch of claim 1, wherein the array of few-mode fibers comprises graded-index fibers.

3. The switch of claim 1, wherein the array of few-mode fibers comprises step-index fibers.

4. The switch of claim 1, wherein the beam stretcher comprises two pairs of cylindrical lenses whose focal lengths are chosen to produce different magnification factors in the horizontal and vertical directions.

5. The switch of claim 1, wherein the spatial light modulator uses liquid crystal on silica technology.

6. The switch of claim 1, wherein the spatial light modulator comprises polarization insensitive.

7. The switch of claim 1, wherein the wavelength (de)multiplexer comprises a reflective grating.

8. The switch of claim 1, wherein the wavelength (de)multiplexer comprises a transmissive grating.

9. The switch of claim 1, wherein the wavelength (de)multiplexer comprises a glass prism.

10. The switch of claim 1, comprising two pairs of cylindrical lenses with horizontal focal lengths of fₓ₁ and fₓ₂ and vertical focal lengths of f_{y1} and f_{y2}, where fₓ₁+fₓ₂=f_{y1}+f_{y2}, wherein the lenses are positioned at exactly their focal length from the input and output planes and wherein an image formed at the output plane is magnified by Mₓ=fₓ₂/fₓ₁ horizontally and M_{y}=f_{y2}/f_{y1} vertically relative to the image at the input plan, where Mₓ and M_{y} can be chosen independently.

11. A system, comprising:
a first optical switch;
an array of parallel few-mode fibers stacked vertically and connected to the first optical switch;
a second optical switch, including:
beam stretchers that modifies an aspect ratio between a height and a width of beams associated with each few-mode fiber;
a spatial light modulator with a 2D array of independently programmed tunable pixels, wherein the spatial light modulator manipulates phase and/or amplitude at each position of an incident optical beam;
a wavelength demultiplexer to separate the spectral components of an incident beam in angle; and
lenses for imaging the modes of the input array of fiber to the spatial light modulator.

12. The system of claim 11, wherein the array of few-mode fibers comprises graded-index fibers.

13. The system of claim 11, wherein the array of few-mode fibers comprises step-index fibers.

14. The system of claim 11, wherein the beam stretcher comprises two pairs of cylindrical lenses whose focal lengths are chosen to produce different magnification factors in the horizontal and vertical directions.

15. The system of claim 11, wherein the spatial light modulator uses liquid crystal on silica technology.

16. The system of claim 11, wherein the spatial light modulator comprises polarization insensitive.

17. The system of claim 11, wherein the wavelength (de)multiplexer comprises a reflective grating.

18. The system of claim 11, wherein the wavelength (de)multiplexer comprises a transmissive grating.

19. The system of claim 11, wherein the wavelength (de)multiplexer comprises a glass prism.

20. The system of claim 11, comprising two pairs of cylindrical lenses with horizontal focal lengths of fₓ₁ and fₓ₂ and vertical focal lengths of f_{y1} and f_{y2}, where fₓ₁+fₓ₂=f_{y1}+f_{y2}, wherein the lenses are positioned at exactly their focal length from the input and output planes and wherein an image formed at the output plane is magnified by Mₓ=fₓ₂/fₓ₁ horizontally and M_{y}=f_{y2}/f_{y1} vertically relative to the image at the input plan, where Mₓ and M_{y} can be chosen independently.
